(19) United States
(12) Patent Application Publication
(10) Pub. No.: US 2014/0358904 A1
(43) Pub. Date: Dec. 4, 2014

(54) SYNONYM IDENTIFICATION BASED ON SELECTED SEARCH RESULT

(71) Applicants: P. Pandurang Nayak, Palo Alto, CA (US); Kedar Dhamdhere, Sunnyvale, CA (US); John Ogden Lamping, Los Altos, CA (US)

(72) Inventors: P. Pandurang Nayak, Palo Alto, CA (US); Kedar Dhamdhere, Sunnyvale, CA (US); John Ogden Lamping, Los Altos, CA (US)

(73) Assignee: GOOGLE INC., Mountain View, CA (US)

(21) Appl. No.: 13/564,882

(22) Filed: Aug. 2, 2012

Related U.S. Application Data
(60) Provisional application No. 61/650,085, filed on May 22, 2012.

(51) Int. Cl. G06F 17/30

(52) U.S. Cl. 707/723; 707/722; 707/E17.014

(57) ABSTRACT

Methods, systems, and apparatus, including computer programs encoded on a computer storage medium, for evaluating terms that are candidate substitute terms for query terms, and revising search queries to include substitute terms. When search results are returned in response to a search query, text associated with a search result is examined to identify a particular term that is not found in the search query. The association score for the particular term as a substitute for a query term is incremented.

### CROSS REFERENCE TO RELATED APPLICATIONS

This application claims the benefit of U.S. Provisional Application No. 61/650,085, filed May 22, 2012, which is incorporated herein by reference in its entirety for all purposes.

### BACKGROUND

This specification generally relates to search engines, and one particular implementation relates to evaluating terms that are substitutes for query terms.

Because users often have difficulty formulating good search queries, automated query revision techniques are used to revise search queries to include variations in the breadth or specificity of query terms. Terms that are not found in a search query can be substituted for query terms in order to revise or expand the search query, and to identify additional results.

### SUMMARY

In general, one innovative aspect of the subject matter described in this specification can be embodied in methods that include the actions of evaluating terms that are candidate substitute terms for query terms, and revising search queries to include substitute terms. In selecting terms to use as substitutes for query terms within a search query, the system may assign and store an association score for a candidate substitute term with respect to a query term or search query. Candidate substitute terms with higher association scores may be designated as substitute terms for the query term, and may be used to revise queries that include the query term.

In some implementations, when search results are returned in response to a search query, text associated with a search result is examined to identify a particular term that is not found in the search query. The association score for the particular term as a substitute for a query term may be incremented. In some embodiments, the text of multiple different search results is examined, and the association score for the particular term is incremented if the particular term appears in at least a predetermined proportion of the search result texts. The results of multiple search queries can be evaluated, and association scores can be aggregated for different candidate substitute terms and query terms. When an additional search query that includes a particular query term is received, a query revision engine may expand the additional search query to include query terms that are designated as substitute terms for the particular query term.

Other embodiments of this aspect include corresponding systems, apparatus, and computer programs, configured to perform the actions of the methods, encoded on computer storage devices.

These and other embodiments can each optionally include one or more of the following features. The associated text may be a snippet associated with one of the selected search results. The selected search results may be the top n ranked search results. The association score may be incremented based on the fraction of search results with text that includes the identified term.

The selected search results may be a result selected by a user or may be a user-selected result and results ranked above the user-selected result. The association score may be incremented in response to text associated with a user-selected result including the identified term and text associated with higher-ranked results not including the identified term. The system may identify and increment multiple association scores for different query terms. The identified term may be determined not to be a substitute term for the query term and also determined not to be an excluded term.

Particular embodiments of the subject matter described in this specification can be implemented so as to realize one or more of the following advantages. By evaluating the suitability of a term for use a substitute based on the presence of the term in text associated with a search result, query generation can be modified to more accurately substitute query terms for those terms that will yield more relevant search results. Furthermore, by evaluating the presence and absence of terms in the text associated with user-selected search results, the system modifies association scores based on the direct behavior of users.

Additionally, implementations described herein effectively leverage the logic responsible for generating the snippets associated with returned search results, allowing the selection of text to display as part of a snippet to influence the suitability of terms found within the snippet as substitutes for terms within a search query.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1, 4 and 5 illustrate the evaluation of snippets on a search results page in order to identify candidate substitute terms for use in further search queries.

FIG. 2 is a flow diagram illustrating an example process for evaluating a search results page in order to identify candidate substitute terms for use in further search queries.

FIG. 3 is a block diagram illustrating an example system for carrying out an internet search including substituting terms when evaluating search queries.

Like reference numbers and designations in the various drawings indicate like elements.

### DETAILED DESCRIPTION

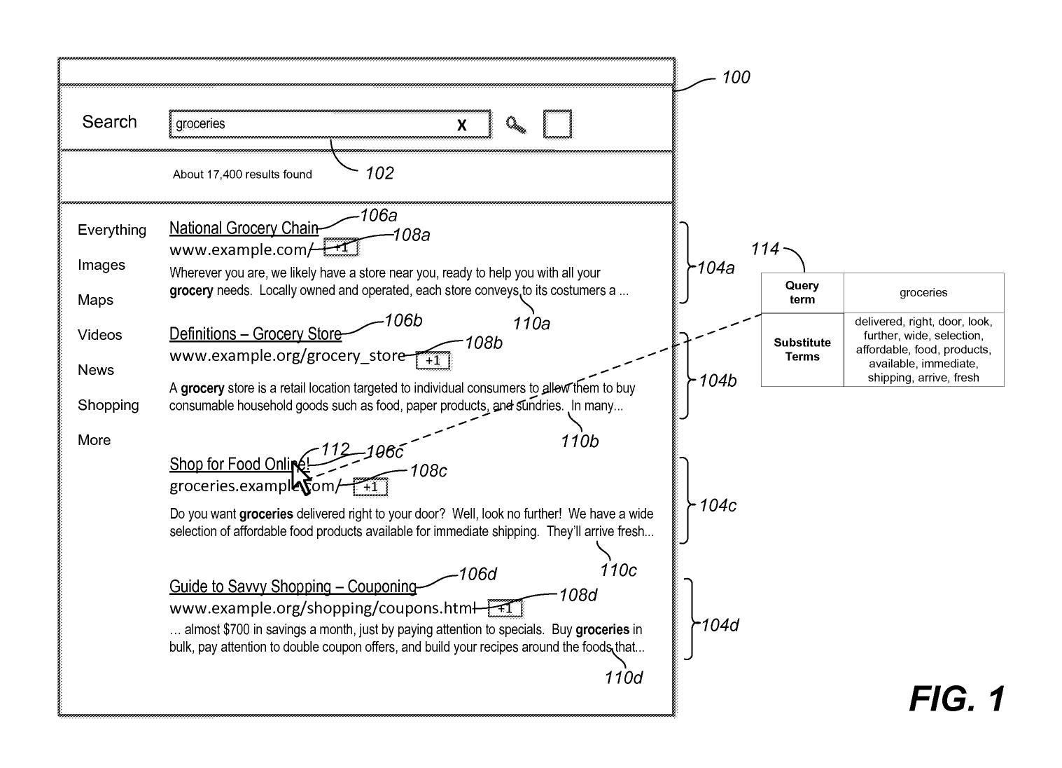

FIG. 1 illustrates a search results page 100 according to an example implementation of the present disclosure. The system evaluates one or more portions of the text presented on the search results page 100 in order to evaluate the suitability of terms as substitutes for query terms within further search queries. In some embodiments, the portions of text include snippets of text that are extracted from resources referenced by the search results.

In response to a user's submission of a search query including the query term “groceries,” as shown in the search box 102, a search system displays search results 104 on the search results page 100. Each search result references a resource that the system has identified as responsive to the search query. The user can select the search result in order to access the referenced resource. In the example shown in FIG. 1, four search results 104a-d are shown. Each search result 104 includes, among other things, a title 106, which may be a hyperlink suitable for selection by a user to return a resource associated with the search result 104. Each search result 104 may include a display uniform resource locator (or “display URL”) 108, a snippet 110 of text, and other information.

Each snippet 110 represents content available on the resource associated with the search result 104. As shown, terms of the search query that appear in the snippet 110, or substitute terms for the terms of the search query that appear in the snippet 110, may be presented in bold or otherwise highlighted within the snippet 110. The snippet 110 provides a preview to the user of the content of the resource, and may aid the user in determining whether to select a search result 104 in order to visit an associated resource.

In the example illustrated by FIG. 1, a user selects a particular search result 104c as illustrated by the cursor 112. The user's selection of the search result 104c is logged by the search system and used to influence further decisions regarding the presentation of search results in response to other search queries. Particularly, the relationship between the content of the snippet 110c associated with the selected search result 104c and the search query is identified, as illustrated in the table 114, and may be used to evaluate the suitability of terms in the snippet as substitutes for query terms in further search queries.

Some of the query terms within a search query may be associated with one or more terms that can be substituted for the query term within a search query. Each listed candidate substitute term may have an association score for the query term. The association scores may be used by the system when choosing if and how to revise future queries that include the query term. For example, the terms with high association scores may be used to generate revised queries. Words with lower association scores may not be substituted for query terms within the search query. Furthermore, search results including terms with high association scores may be evaluated as more relevant results than search results including terms with low association scores.

Many of the terms found in the snippet 110c are listed on the table 114 as candidate substitute terms for the query term “groceries”. In some embodiments, the system may identify terms that fit certain criteria from text related to the selected result 104c. For example, there may be a list of words that are not included, because they commonly appear in snippets without being substantively relevant. In the example from FIG. 1, the terms “do”, “you”, “want”, “to”, “your”, “well”, “no”, “we”, “have”, “a”, “of”, “for”, and “they'll” are not included on the table 114 because they are blacklisted terms that frequently appear in text generally. Because the frequency of these blacklisted terms in the context of the selected search result is not due to a close association with the particular subject matter being searched, the blacklisted terms may be excluded from consideration as substitutes for query terms within further search queries.

After the system has evaluated the search results 104 and user behavior regarding the search page 100 and made changes to the association scores of one or more identified terms relative to query terms, the changes may then be aggregated with changes made in response to similar evaluations of other search pages and in response to other users. Over time, the aggregated association score for each candidate substitute term with respect to query terms may more accurately reflect the association between the terms and applicability of the term as a substitute when the query term is entered as part of further similar search queries. The term's association score as a substitute for a query term, aggregated over multiple instances with multiple users, can be supplied into a query revision engine, synonym engine, or a scoring engine in order to develop rules based on this information.

In some implementations, the system may also aggregate information about substitute terms across multiple different search queries that each include the query term. Association scores could be aggregated across all queries that include the query term, or over only a subset of queries that include the query term and that also meet certain criteria. For example, association scores for a particular query term may be aggregated across all queries with the same terms immediately preceding or succeeding the query term. Where information about a candidate substitute term for a query term is aggregated across multiple queries, the aggregated information may be used to develop rules about the use of the term as a substitute for the query term in any of the queries included in the aggregation.

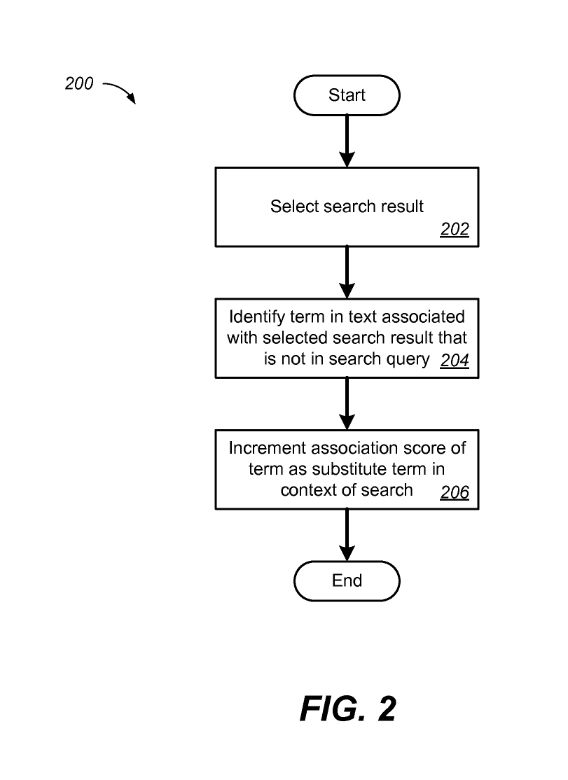

FIG. 2 is a flow diagram illustrating an example process 200 according to an implementation of the present disclosure. Specifically, the system selects one or more search results, returned in response to a search query (202). As the shown examples illustrate, in some implementations, the selection may be based on a choice made by a user, such as the search result selected by the user. The search results ranked above the selected search result may also be included in the selection. In some implementations, text from one or more of the top-ranked search results may be selected for evaluation by the system, instead of or in addition to basing the selection on user activity.

The system determines that, for text associated with one of the selected search results, a term that is not within the search query appears in the text (204). In the illustrated examples, the associated text is snippets associated with the search results. In addition to snippets, other associated text from the search result, such as the title, links, reviews, or text within the content of the resource itself could be used, either alone or with other result text.

In some embodiments, the determination is further that the identified term is found in the text associated with all of the selected search results, or present in at least some fraction of them. In some implementations where a fraction or other threshold is used, presence or absence from the text of each of the search results may not be equally weighted; for example, where a user-selected search result is included in the set of selected search results, the presence of the query term in the user-selected result may have more weight than its presence other results. The term's presence in higher-ranked results may also have greater weight.

In some implementations, a user-selected search result and higher ranked search results may be used, and the evaluation from the identified term may depend on a comparison of the user-selected search result with the more highly ranked results. For example, if the substitute term is absent from one or more of the more highly ranked results but present in the user-selected result, that may be evaluated even more highly than if the term is also present in the higher ranked results.

Having determined the term's presence in the text, the association score of the identified term relative to one or more of the query terms within the search query is incremented in the system (206). In some implementations, the score may be incremented by a set amount. In other implementations, the amount that the score is incremented may depend on the proportion of search results with text that includes the identified term, the reliability of the user, the frequency of occurrence of the identified term in the user's search history or the system's general search history, how highly ranked the selected search results are, or the results of factors weighed manually or according to a machine learning process.

For example, if text from multiple search results is evaluated and all of the search results have text including an identified term, then the association score of the identified term relative to a query term may be incremented by one value. If, instead, a proportion of 0.8 of the evaluated search results include the identified term, then the association score may be incremented by another value. A term that does not appear in the text associated with any selected search result may not be incremented at all.

As a further example, a first user may tend to select search results that are considered to be more relevant to most users than a second user. If the first user is considered more reliable by the system, then the first user's selection of a search result having a snippet with a term may cause an association score for that term to increment a first value, while the same selection by the second user may cause an increment of a lesser value instead.

Furthermore, in some implementations, a machine learning algorithm may have identified texts associated with user-selected results as providing a more relevant evaluation of candidate synonyms. So, for example, a user selecting the top-ranked search result with a snippet that includes a term may increment that term's association with a query term by one value, while a user selecting a search result ranked fifth with a snippet that includes the term may instead increment that term's association with a query term by another value. In other circumstances, such as another user or a different query, the system may have come to the opposite conclusion and weigh higher-ranked search results more heavily for changing the association score than lower-ranked search results.

Further rules may be used to evaluate which query terms to associate the identified term with. In some implementations, rules such as existing association scores, known synonyms, parts of speech, and the presence or absence of query terms within the text may be used to determine which association scores should be modified. For example, text from a search result may include all of the query terms in the search query except one, and may additionally include the evaluated term. In some implementations, the association score between the substitute term and the absent query term may be the only association score that is incremented. In another example, three of the query terms in the search query may be the same part of speech as the identified term, and so the association score for the term as a substitute for each of the three query terms may be incremented in some implementations.

In addition to modifying existing association scores between candidate substitute terms for query terms, the identified term may be a term that is not otherwise associated with a query term for which is now identified as a candidate substitute term. In this case, incrementing an association score may involve associating the identified term with a query term and giving it an association score, which may be understood to be incrementing what had been an association score of zero. The addition of a new association between the query term and the identified term and the creation of a new association score for a query term is therefore also properly thought of as incrementing an association score as described herein.

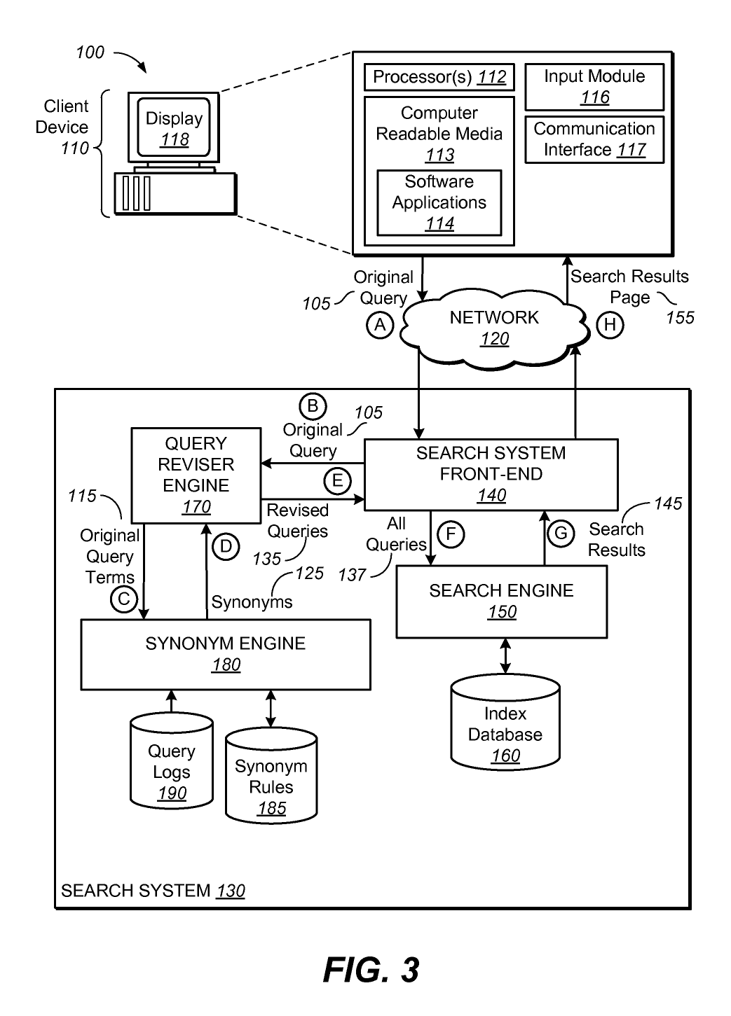

FIG. 3 is a block diagram illustrating an example system 300 that can execute implementations of the present disclosure. For example, the system 300 can use additional queries with substitute terms to generate search results. In general, the system 300 includes a client device 310 coupled to a search system 330 over a network 320. The search system 330 includes a search engine 350, a query reviser engine 370, and a synonym engine 380. The search system 330 receives a query 305, referred to by this specification as the “original query” or an “initial query,” from the client device 310 over the network 320. The search system 330 provides a search results page 355, which presents search results 345 identified as being responsive to the query 305, to the client device 310 over the network 320.

In some implementations, the search results 345 identified by the search system 330 can include one or more search results that are identified as being responsive to queries that are different than the original query 305. The search system 330 can generate or obtain other queries in numerous ways (e.g., by revising the original query 305).

In some implementations, the search system 330 can generate a revised query by adding to the original query 305 additional terms that are synonyms of one or more terms that occur in the original query 305. In other implementations, the search system 330 can generate a revised query by substituting terms that are synonyms of terms that occur in the original query 305, in place of the terms in the original query 305. The synonym engine 380 can determine the additional terms that are candidate synonyms for the one or more terms that occur in the original query. The query reviser engine 370 can generate the revised query. The search engine 350 can use the original query 305 and the revised queries to identify and rank search results. The search engine 350 can provide the identified search results 345 to the client device 310 on the search results page 355.

The synonym engine 380 can identify the synonyms that the query reviser engine 370 can use to generate revised queries by evaluating terms included in previously received queries stored in a query logs database 390. The queries stored in the query logs database 390 can include previous queries where a user considered the results of the queries desirable. For example, the user can click the provided search results from a query, in effect, validating the search results. The queries stored in the query logs database 390 can include previous queries determined by the search system 330 as providing desirable results. Each of these events, as well as the events described in the examples, may influence an association score for identified terms associated with query terms within the search query. In considering whether to substitute an identified term in a revised query, the system may evaluate the association score for that identified term and only submit revised queries with substituted terms that exceed an association score threshold.

After results are returned, the search system 330 can then perform a quality thresholding for returned search results from a query. The quality thresholding can include determining search results that have historically been returned for a particular query. Search results above the quality threshold can validate a query, which the search system 330 can then include in the query logs database 390.

For example, given a first term (“cat”), the synonym engine 380 can evaluate terms (“feline” or “banana”) that are candidate synonyms for the original term. In addition, the synonym engine 380 can determine that certain terms are synonyms of the first term (as in the case of “feline”), and that other terms are not synonyms of the first term (as in the case of “banana”). The synonym engine 380 can base this determination on rules stored in a synonym rules database 385. For example, a synonym rule can be “feline” is a synonym for “cat” and “banana” is not a synonym for “cat”. Synonym rules may be based on association scores between each candidate synonym and the original term; for instance, “feline” may have a high association score with “cat” while “banana” has a low association score with “cat”.

The search system 330 can define synonym rules to apply generally, or to apply only when particular conditions, or “query contexts,” are satisfied. For example, the query context of a synonym rule can specify one or more other terms that should be present in the query for the synonym rule to apply. Furthermore, query contexts can specify relative locations for the other terms (e.g., to the right or left of a query term under evaluation). In another example, query contexts can specify a general location (e.g., anywhere in the query). For example, a particular synonym rule can specify that the term “pet” is a synonym for the query term “dog,” but only when the query term “dog” is followed by the term “food” in the query. Multiple distinct synonym rules can generate the same synonym for a given query term. For example, for the query term “dog” in the query “dog food,” the term “pet” can be specified as a synonym for “dog” by both a synonym rule for “dog” in the general context and a synonym rule for “dog” when followed by “food.”

The synonym rules can depend on query contexts that define other terms in the original query 305. In other words, a synonym rule need not apply in all situations. For example, when the term “cats” is used as a single-term query, the term “felines” can be considered a synonym for “cats”. The synonym engine 380 can return the term “felines” to the query reviser engine 370 to generate a revised search query. In another example, when the query includes the term “cats” followed by the term “musical,” a synonym rule can specify that the term “felines” is not a synonym for “cats.” In some implementations, the synonym rules can be stored in the synonym rules database 385 for use by the synonym engine 380, the query reviser engine 370, or the search engine 350.

In the illustrative example of FIG. 3, the search system 330 can be implemented as computer programs installed on one or more computers in one or more locations that are coupled to each other through a network (e.g., network 320). The search system 330 includes a search system front-end 340 (e.g., a “gateway server”) that coordinates requests between other parts of the search system 330 and the client device 310. The search system 330 also includes one or more “engines”: the search engine 350, a query reviser engine 370, and the synonym engine 380.

As used in this specification, an “engine” (or “software engine”) refers to a software implemented input/output system that provides an output that is different from the input. An engine can be an encoded block of functionality, such as a library, a platform, a Software Development Kit (“SDK”), or an object. The network 320 can include, for example, a wireless cellular network, a wireless local area network (WLAN) or Wi-Fi network, a Third Generation (3G) or Fourth Generation (4G) mobile telecommunications network, a wired Ethernet network, a private network such as an intranet, a public network such as the Internet, or any appropriate combination thereof.

The search system front-end 340, the search engine 350, the query reviser engine 370, and the synonym engine 380 can be implemented on any appropriate type of computing device (e.g., servers, mobile phones, tablet computers, notebook computers, music players, e-book readers, laptop or desktop computers, PDAs, smart phones, or other stationary or portable devices) that includes one or more processors and computer readable media. Among other components, the client device 310 includes one or more processors 312, computer readable media 313 that store software applications 314 (e.g., a browser or layout engine), an input module 316 (e.g., a keyboard or mouse), a communication interface 317, and a display device 318. The computing device or devices that implement the search system front-end 340, the query reviser engine 370, and the search engine 350 may include similar or different components.

In general, the search system front-end 340 receives the original query 305 from the client device 310. The search system front-end 340 routes the original query 305 to the appropriate engines included in the search system 330 so that the search system 330 can generate the search results page 355. In some implementations, routing occurs by referencing static routing tables. In other implementations, routing occurs based on the current network load of an engine, in order to accomplish load balancing. In addition, the search system front-end 340 can provide the resulting search results page 355 to the client device 310. In doing so, the search system front-end 340 acts as a gateway, or interface, between the client device 310 and the search engine 350.

Two or more of a search system front-end, a query reviser engine and a search engine (e.g., the search system front-end 340, the query reviser engine 370, and the search engine 350, respectively) may be implemented on the same computing device, or on different computing devices. Because the search system 330 generates the search results page 355 based on the collective activity of the search system front-end 340, the query reviser engine 370, and the search engine 350, the user of the client device 310 may refer to these engines collectively as a “search engine.” This specification, however, refers to the search engine 350, and not the collection of engines, as the “search engine,” since the search engine 350 identifies the search results 345 in response to the user-submitted query 305.

In some implementations, the search system 330 can include many computing devices for implementing the functionality of the search system 330. The search system 330 can process the received queries and generate the search results by executing software on the computing devices in order to perform the functions of the search system 330.

Referring to FIG. 3, during time (A), a user of the client device 310 enters original query terms 315 for the original query 305, and the client device 310 communicates the original query 305 to the search system 330 over the network 320. For example, the user can submit the original query 305 by initiating a search dialogue on the client device 310, speaking or typing the original query terms 315 of the original query 105, and then pressing a search initiation button or control on the client device 310. The client device 310 formulates the original query 305 (e.g., by specifying search parameters). The client device 310 transmits the original query 305 over the network 320 to the search system 330.

Although this specification refers to the query 305 as an “original” or an “initial” query, such reference is merely intended to distinguish this query from other queries, such as the revised queries that are described below. The designation of the original query 305 as “original” is not intended to require the original query 305 to be the first query that is entered by the user, or to be a query that is manually entered. For example, the original query 305 can be the second or subsequent query entered by the user. In another example, the original query 305 can be automatically derived (e.g., by the query reviser engine 370). In another example, the original query 305 can be modified based on prior queries entered by the user, location information, and the like.

During time (B), the search system front-end 340 receives the original query 305 and communicates the original query 305 to the query reviser engine 370. The query reviser engine 370 can generate one or more revised queries 335 based on the substance of the original query 305. In some implementations, the query reviser engine 370 generates a revised query by adding terms to the original query 305 using synonyms 325 for terms in the original query 305. In other implementations, the query reviser engine 370 generates a revised query by substituting the synonyms 325 for the corresponding terms of the original query 305. The query reviser engine 370 can obtain synonyms 325 for use in revising the original query 305 from the synonym engine 380.

During time (C), the query reviser engine 370 communicates original query terms 315 of the original query 305 to the synonym engine 380. The synonym engine 380 can use synonym rules included in the synonym rules database 385 to determine one or more synonyms 325 for one or more of the original query terms 315 of the original query 305. Where synonym rules are not defined, the synonym engine 380 may further use association scores to identify synonyms 325 that have high association scores in relation to one or more of the original query terms 315 of the original query. Alternatively, the association scores may be used during offline processing to generate the synonym rules in the synonym rules database 385, which provides the runtime process by which synonyms 325 are determined.

The synonym engine 380 communicates synonyms 325 to the query reviser engine 370 during time (D). The query reviser engine 370 generates one or more revised queries 335 by adding synonyms 325 to the original query 305. In addition, the query reviser engine 370 can generate one or more revised queries 335 by substituting certain terms of the original query 305.

The query reviser engine 370 communicates the one or more revised queries 335 to the search system front-end 340 during time (E). The search system front-end 340 communicates the original query 305 along with the one or more revised queries 335 to the search engine 350 as all queries 337 during time (F). The search engine 350 generates search results 345 that it identifies as being responsive to the original query 305 and/or the one or more revised queries 335. The search engine 350 can identify search results 345 for each query using an index database 360 that stores indexed resources (e.g., web pages, images, or news articles on the Internet). The search engine 350 can combine and rank the identified search results 345 and communicate the search results 345 to the search system front-end 340 during time (G).

The search system front-end 340 generates a search results page 355 that identifies the search results 345. For example, each of the search results 345 can include, but are not limited to, titles, text snippets, images, links, reviews, or other information. The original query terms 315 or the synonyms 325 that appear in the search results 345 can be formatted in a particular way (e.g., in bold print and/or italicized print). For example, the search system front-end 340 transmits a document that includes markup language (e.g., HyperText Markup Language or eXtensible Markup Language) for the search results page 355 to the client device 310 over the network 320 at time (H). The client device 310 reads the document (e.g., using a web browser) in order to display the search results page 355 on display device 318. The client device 310 can display the original query terms 315 of the original query 305 in a query box (or “search box”), located, for example, on the top of the search results page 355. In addition, the client device 310 can display the search results 345 in a search results box, for example, located on the left-hand side of the search results page 355.

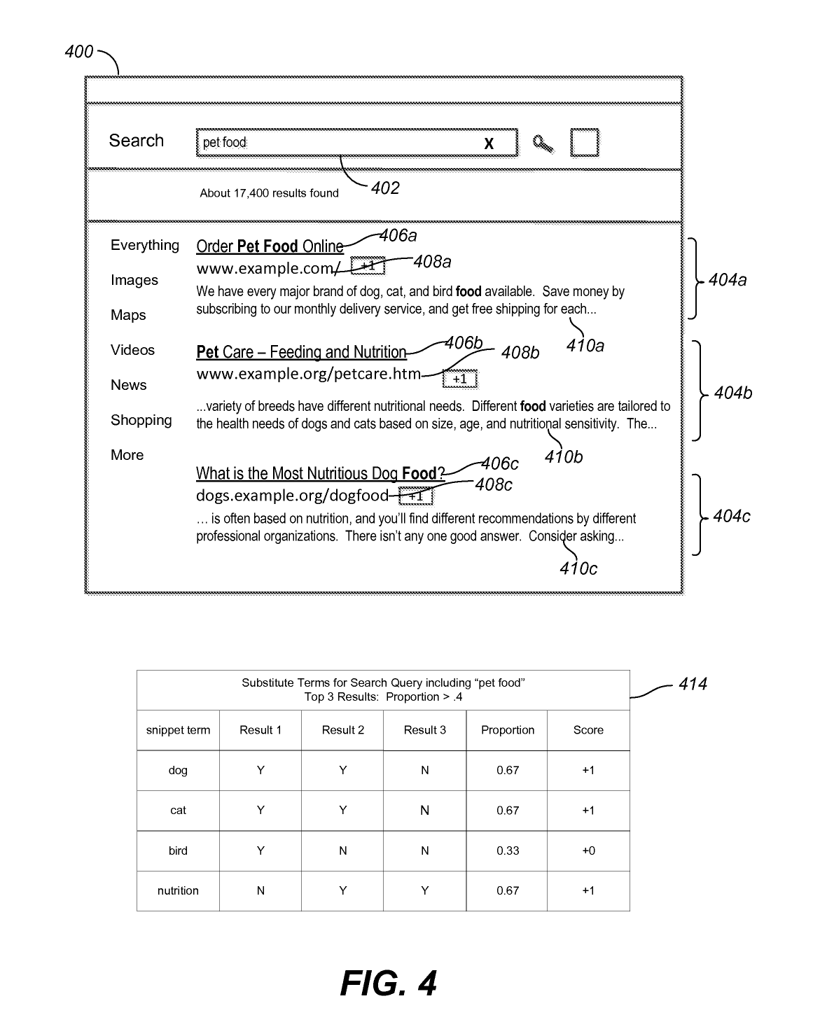

FIG. 4 illustrate the evaluation of snippets on a search results page 400 in order to identify candidate substitute terms for use in further search queries. The search results page 400 is returned in response to a search query including the query terms “pet food”, as shown in the search box 402. The search results page 400 presents search results 404a-c to a user, as described above with respect to the search results page 100 of FIG. 1. Each of the three search results 404 shown on the results page 400 includes a title 406, display URL 408, and snippet 410.

As illustrated by the chart 414, the process for determining whether to modify the association scores of identified terms is not necessarily dictated by the user's selection of a search result 404. For example, the top-ranked search results can be used. In the example shown, the top three search results 404a, 404b, and 404c are used. The snippets 410a-c for these three search results 404a-c are evaluated to determine what proportion of the snippets include each of the identified terms. The proportion is then compared to a threshold, which in this case is set to 0.4; for each identified term, if the proportion of snippets including that query term exceeds 0.4, the association score for that term as a substitute for a query term of the search query will be incremented.

As shown in the chart 414, the first result snippet 410a includes the words “dog”, “cat”, and “bird”. The second result snippet 410b includes “dog”, “cat” and “nutrition”. The third result snipped 410c includes “nutrition”. Therefore, the proportion of snippets including each of “dog”, “cat”, and “nutrition” is 0.67, which exceeds the threshold 0.4, and so the association scores for “dog”, “cat”, and “nutrition” as substitutes for query terms within further search queries may each be incremented. The proportion of snippets including “bird” is 0.33, which does not exceed the threshold 0.4, and therefore the association score for “bird” as a substitute for query terms within further search queries is not incremented.

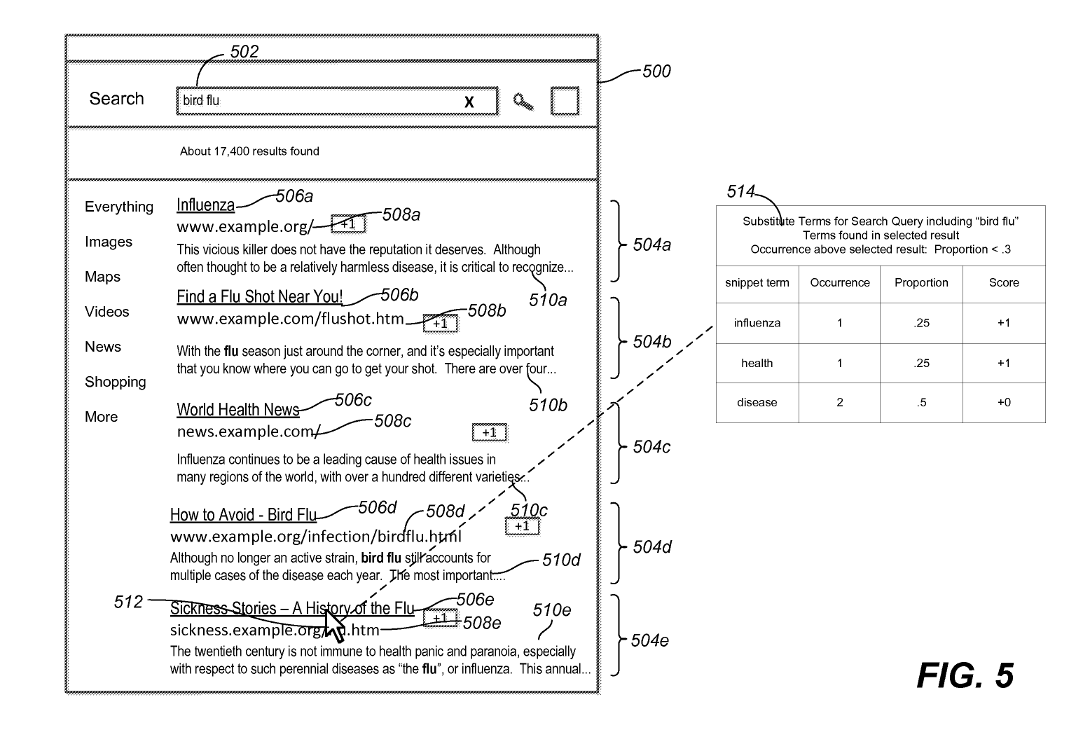

FIG. 5 illustrates a search results page 500 according to another implementation of the present disclosure. The search results page 500 is generated responsive to a search query including the terms “bird flu” as shown in the search box 502. The search results page 500 is similar to the results pages 100 and 400 earlier described with respect to FIGS. 1 and 4. The search results page 500 displays five search results 504a-e, each including a title 506, display URL 508, and snippet 510.

The user selects the fifth search result 504a, as illustrated by the cursor 512. In this example, as shown by the chart 514, the snippets 510 associated with the user-selected search result 504e and each of the search results 504 ranked above the selected search result 504e are evaluated to identify suitable substitute terms for query terms in further search queries. Terms that are present in the selected search result 504e and also absent from one or more of the higher-ranked results 504a-d are identified as suitable substitute terms and have their association scores incremented.

Terms found in the snippet 510e associated with the user-selected search result 504e are identified. For each identified term, the proportion of higher-ranked snippets 510 that include the term is evaluated against a threshold, which in this example is set to 0.3. The association score for each term that appears in a proportion of snippets less than 0.3 will be incremented; each candidate substitute term that is evaluated to appear in a proportion of snippets exceeding 0.3 will not be incremented.

As shown in the chart 514, the terms “influenza”, “health”, and “disease” are identified within the snippet 510e associated with the selected result 504e. One of the four snippets 510a-d associated with higher-ranked results 504a-d also includes the query term “influenza”. This represents a proportion of 0.25, which is less than 0.3; therefore, the association score of “influenza” with respect to a query term may be incremented. Similarly, only one of the four snippets 510a-d includes the word “health”, which is again a proportion of 0.25, so the association score of “health” may also be incremented. In contrast, the term “disease” appears in two of the four snippets 510a-d, which is a proportion of 0.5. Because this proportion exceeds the threshold 0.3, the association score for “disease” may not be implemented, as shown in the chart 514.

After the system has evaluated the search results 504 and user behavior regarding the search page 500 and made changes to the association scores of one or more identified terms relative to query terms, the changes may then be aggregated with changes made in response to similar evaluations of other search pages and in response to other users. Over time, the aggregated association score for each candidate substitute term with respect to query terms may more accurately reflect the association between the terms and applicability of the term as a substitute when the query term is entered as part of further similar search queries. The term's association score as a substitute for a query term, aggregated over multiple instances with multiple users, can be supplied into a query revision engine, synonym engine, or a scoring engine in order to develop rules based on this information.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
selecting one or more search results from among multiple search results that are returned in response to a search query;
identifying a term that (i) occurs in text associated with the selected search results, and (ii) does not occur in the search query;
incrementing an association score for the identified term as a substitute term for a term that occurs in the search query.

2. The method of claim 1, wherein the text associated with the selected search result is a snippet associated with one of the selected search results.

3. The method of claim 1, wherein the selected one or more search results is a user-selected search result.

4. The method of claim 1, wherein the selected one or more search results are a top n ranked search results.

5. The method of claim 1, wherein identifying the one or more search results comprises identifying a search result selected by a user and one or more search results ranked higher than the selected search result.

6. The method of claim 5, further comprising:
for each of the identified search results, determining whether the snippet associated with the search result includes the identified term; and
evaluating the proportion of selected search results with snippets that include the identified term against a threshold;
wherein the association score is incremented in response to determining that the proportion satisfies the threshold.

7. The method of claim 5, further comprising:
for each of the identified search results, determining whether the snippet associated with the search result includes the identified term;
wherein the association score is incremented in response to determining that the identified term occurs in the user-selected search result and does not occur in one or more of the search results that are ranked higher than the selected search result.

8. The method of claim 1, the search query comprising multiple query terms, the method further comprising:
for each of the multiple query terms of the search query, incrementing an association score for the identified term as a substitute term for that query term.

9. The method of claim 1, wherein identifying the term further comprises:
determining that the term is not identified as a substitute term for the term occurring in the search query, and
determining that the term is not identified as an excluded term.

10. The method of claim 1, further comprising:
in response to an additional search query that includes the query term, generating a revised query that includes the identified term based on the incremented association score; and
evaluating search results identified in response to the revised query.

11. A system comprising:
one or more computers and one or more storage devices storing instructions that are operable, when executed by the one or more computers, to cause the one or more computers to perform operations comprising:
selecting one or more search results from among multiple search results that are returned in response to a search query;
identifying a term that (i) occurs in text associated with the selected search results, and (ii) does not occur in the search query;
incrementing an association score for the identified term as a substitute term for a term that occurs in the search query.

12. The system of claim 11, wherein the text associated with the selected search result is a snippet associated with one of the selected search results.

13. The system of claim 11, wherein the selected one or more search results is a user-selected search result.

14. The system of claim 11, wherein the selected one or more search results are a top n ranked search results.

15. The system of claim 11, wherein identifying the one or more search results comprises identifying a search result selected by a user and one or more search results ranked higher than the selected search result.

16. The system of claim 15, the operations further comprising:
for each of the identified search results, determining whether the snippet associated with the search result includes the identified term; and
evaluating the proportion of selected search results with snippets that include the identified term against a threshold;
wherein the association score is incremented in response to determining that the proportion satisfies the threshold.

17. The system of claim 15, the operations further comprising:
for each of the identified search results, determining whether the snippet associated with the search result includes the identified term;
wherein the association score is incremented in response to determining that the identified term occurs in the user-selected search result and does not occur in one or more of the search results that are ranked higher than the selected search result.

18. The system of claim 11, the search query comprising multiple query terms, the operations further comprising:
for each of the multiple query terms of the search query, incrementing an association score for the identified term as a substitute term for that query term.

19. The system of claim 11, wherein identifying the term further comprises:
determining that the term is not identified as a substitute term for the term occurring in the search query, and
determining that the term is not identified as an excluded term.

20. The system of claim 11, the operations further comprising:
in response to an additional search query that includes the query term, generating a revised query that includes the identified term based on the incremented association score; and
evaluating search results identified in response to the revised query.

21. A non-transitory computer-readable medium storing software comprising instructions executable by one or more computers which, upon such execution, cause the one or more computers to perform operations comprising:
selecting one or more search results from among multiple search results that are returned in response to a search query;
identifying a term that (i) occurs in text associated with the selected search results, and (ii) does not occur in the search query;
incrementing an association score for the identified term as a substitute term for a term that occurs in the search query.

22. The medium of claim 21, wherein identifying the one or more search results comprises identifying a search result selected by a user and one or more search results ranked higher than the selected search result.

23. The medium of claim 22, the operations further comprising:
for each of the identified search results, determining whether the snippet associated with the search result includes the identified term; and
evaluating the proportion of selected search results with snippets that include the identified term against a threshold;
wherein the association score is incremented in response to determining that the proportion satisfies the threshold.

24. The medium of claim 22, the operations further comprising:
for each of the identified search results, determining whether the snippet associated with the search result includes the identified term;
wherein the association score is incremented in response to determining that the identified term occurs in the user-selected search result and does not occur in one or more of the search results that are ranked higher than the selected search result.

25. The medium of claim 21, the operations further comprising:
in response to an additional search query that includes the query term, generating a revised query that includes the identified term based on the incremented association score; and
evaluating search results identified in response to the revised query.
